(19) United States
(12) Patent Application Publication
(10) Pub. No.: US 2019/0025947 A1
(43) Pub. Date: Jan. 24, 2019

(54) MOUSE DEVICE

(71) Applicant: Primax Electronics Ltd., Taipei (TW)

(72) Inventors: Shen-Pin Wei, Taipei (TW); Tsung-Wen Hsueh, Taipei (TW); Chun-Nan Su, Taipei (TW)

(21) Appl. No.: 15/812,727

(22) Filed: Nov. 14, 2017

(30) Foreign Application Priority Data
Jul. 21, 2017 (TW) 106124632

(51) Int. Cl. G06F 3/0354; G06F 3/0362; G06F 3/038

(52) U.S. Cl. CPC G06F 3/03543; G06F 3/0383; G06F 3/0362

(57) ABSTRACT

The present invention relates to a mouse device, including a scroll wheel, a scroll wheel resolution switching element, a magnetic induction element, and a processing unit connected to the scroll wheel resolution switching element and the magnetic induction element, wherein the scroll wheel includes a magnetic element, and is configured to conduct stepless rotation, the scroll wheel resolution switching element is configured to switch a scroll wheel resolution of the scroll wheel, the magnetic induction element outputs a magnetic induction signal according to an amount of rolling of the scroll wheel, and the processing unit correspondingly generates and outputs a control signal according to the scroll wheel resolution and the magnetic induction signal.

### FIELD OF THE INVENTION

The present invention relates to the field of input devices, and in particular, to a mouse device.

### BACKGROUND OF THE INVENTION

The development changed with each passing day to the science and technology, and the multimedia and computer era has arrived. Moreover, in a computer system, input devices that connect a computer host and a user play a significant role. The input devices include: a mouse device, a keyboard device, and a trackball device, or the like. Since the mouse device may be held by a user with a palm to control movement of a cursor of the mouse, and click selection of an image on a computer screen or function execution may be performed according to operations by fingers of the user, the mouse device has become the most common input device.

For particular requirements, for example, for browsing a webpage or browsing a file, most of the mouse devices are equipped with a scroll wheel for the user to scroll and move the viewed object up and down. A mouse device with a stepless scroll wheel is now provided, which is commonly known as a shuttle wheel mouse, and the scroll wheel may be steplessly and quickly scrolling, in order to accelerate the speed of sliding the object being browsed up and down, thus being conducive to the user to quickly browse.

The conventional shuttle wheel mouse senses the amount of rolling of the scroll wheel by using a light box structure or a mechanical encoder disposed inside, and then outputs a corresponding control signal to control the sliding quantity of the object being browsed, generally, when the scroll wheel rotates for a circle, the shuttle wheel mouse could output a control signal of 20-24 steps, which is regarded as the scroll wheel resolution of the shuttle wheel mouse, but the scroll wheel resolution is fixed and not allowed being controlled by the user, thus the user cannot determine the relative relationship of an amount of rolling of the scroll wheel and a sliding quantity of the object being browsed on basis of the actual browsing needs. Thus, the conventional mouse device has room to improve.

### SUMMARY OF THE INVENTION

The present invention is mainly directed to provide a mouse device, and in particular, relates to a mouse device, a scroll wheel of which is capable of conducting stepless rotation, inducing an amount of rolling of the scroll wheel in the way of magnetic induction, and the scroll wheel resolution of the scroll wheel can be switched.

In a preferable embodiment, the present invention provides a mouse device, including:

a scroll wheel, including a magnetic element, and configured to conduct stepless rotation;

a scroll wheel resolution switching element, configured to switch a scroll wheel resolution of the scroll wheel;

a magnetic induction element, outputting a magnetic induction signal according to an amount of rolling of the scroll wheel; and

a processing unit, connected to the scroll wheel resolution switching element and the magnetic induction element, and correspondingly generating and outputting a control signal according to the scroll wheel resolution and the magnetic induction signal.

### BRIEF DESCRIPTION OF THE DRAWINGS

FIG. 1 is a schematic structural view of the appearance of a mouse device according to a first preferable embodiment of the present invention;

FIG. 2 is a schematic concept diagram of a scenario in which the mouse device shown in FIG. 1 is connected to an electronic device;

FIG. 3 is a schematic structural concept diagram of a part of the mouse device in FIG. 1;

FIG. 4 is a schematic box concept diagram of the mouse device in FIG. 1;

FIG. 5 is a schematic structural view of the appearance of a mouse device according to a second preferable embodiment of the present invention;

FIG. 6 is a schematic box concept diagram of the mouse device in FIG. 5.

FIG. 7 is a schematic box concept diagram of the appearance of a mouse device according to a third preferable embodiment of the present invention.

### DETAILED DESCRIPTION OF THE PREFERRED EMBODIMENT

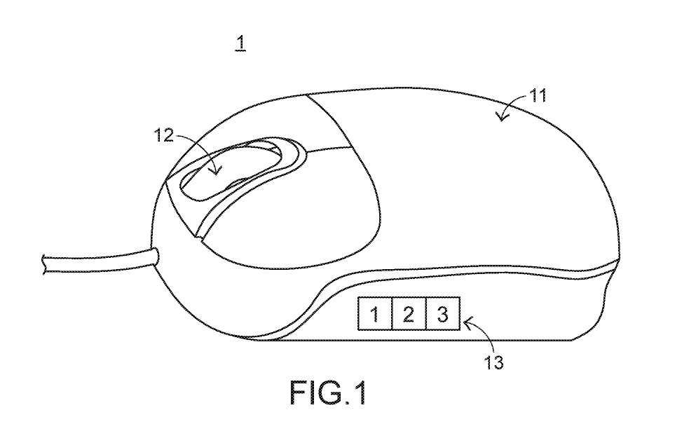

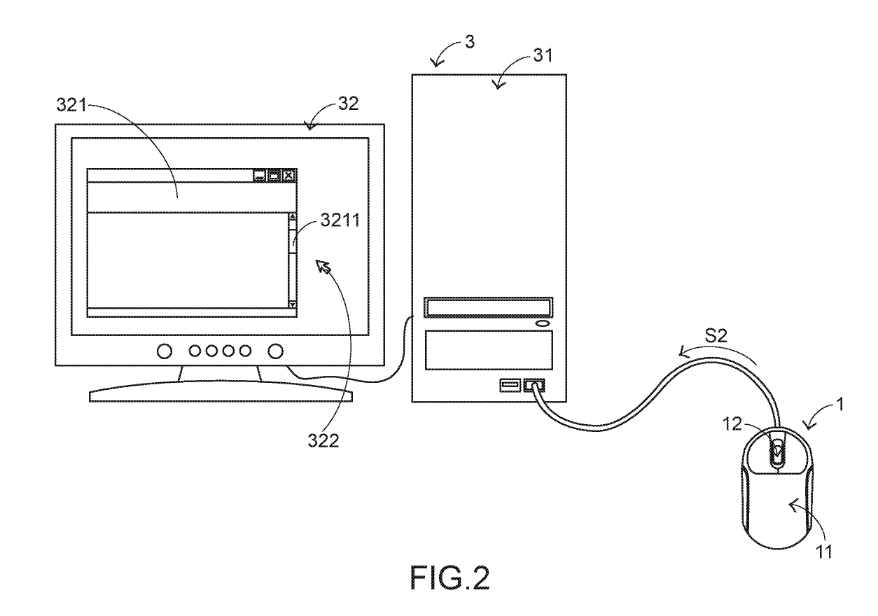

Referring to FIG. 1 and FIG. 2, FIG. 1 is a schematic structural view of the appearance of a mouse device according to a first preferable embodiment of the present invention, and FIG. 2 is a schematic concept diagram of a scenario in which the mouse device shown in FIG. 1 is connected to an electronic device. In this preferable embodiment, the electronic device is a computer system 3, the computer system 3 includes a computer host 31 and a computer screen 32, and the computer host 31 is separately connected to a mouse device 1 and a computer screen 32. Although a wired way is adopted for connection in FIG. 2, but is not limited, a wireless way also can be adopted for connection, and the computer screen 32 may display a cursor 322 and a window 321; the mouse device 1 is to be held by a user with a palm to move, and the computer host 31 then moves the cursor 322 in the computer screen 32 according to a displacement of the mouse device 1. The specific embodiment and operating principles of the process in which the user controls the cursor 322 in the computer screen 32 to move by means of the mouse device 1 are well known by any person skilled in the art, and are not described in detail herein.

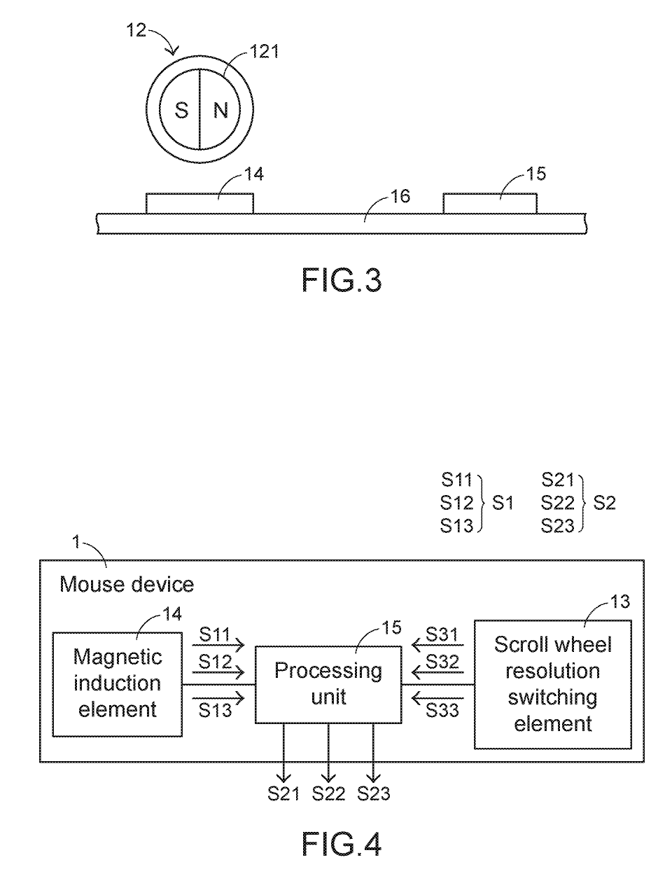

Referring to FIG. 1 to FIG. 4 synchronously, FIG. 3 is a schematic structural concept diagram of a part of the mouse device in FIG. 1, and FIG. 4 is a schematic box concept diagram of the mouse device in FIG. 1. The mouse device 1 includes a case 11, a scroll wheel 12, a scroll wheel resolution switching element 13, a magnetic induction element 14, a processing unit 15, and a circuit board 16, at least a part of the scroll wheel 12 and the scroll wheel resolution switching element 13 are exposed to the outside of the case 11 for operation by the user, the magnetic induction element 14, the processing unit 15 and the circuit board 16 are all inside the case 11, the magnetic induction element 14 and the processing unit 15 are disposed on the circuit board 16, and the processing unit 15 is connected to the scroll wheel resolution switching element 13 and the magnetic induction element 14. For clarity of illustration, FIG. 3 only shows the scroll wheel 12, the magnetic induction element 14, the processing unit 15 and the circuit board 16.

Moreover, the scroll wheel 12 includes a magnetic element 121, and is rotated by the user for stepless rotation, which is commonly known as a shuttle wheel, the magnetic induction element 14 is disposed near the bottom of the scroll wheel 12, and is separated by a distance from the scroll wheel 12, and the magnetic induction element 14 is configured to induce a magnetic change that is generated when the scroll wheel 12 rolls and outputs a magnetic induction signal S1; the magnetic change generated by different amounts of rolling of the scroll wheel is different, so when the amount of rolling of the scroll wheel 12 is changed because of the rotation by the user, the magnetic induction signal S1 output by the magnetic induction element 14 is also different. Preferably, but not limited, the magnetic induction element 14 could be a Hall sensor chip, inducing variation in magnetic flux generated when the scroll wheel 12 rotates and correspondingly outputting the magnetic induction signal S1.

In the present invention, the user may switch the resolution of the scroll wheel 12 by operating the scroll wheel resolution switching element 13, that's to say, the user can set a controlled amount of rolling for one circle of the scroll wheel 12 according to the actual application needs. The processing unit 15 may generate and output a corresponding control signal S2 to the computer system 3 according to the scroll wheel resolution set by the user and the magnetic induction signal S1 output by the magnetic induction element 14, and then enables the computer system 3 to execute a corresponding instruction. Preferably, but not limited, the scroll wheel resolution switching element 13 may be a mechanical switching element, an optical switching element or a touch switching element.

Subsequently, taking an example to illustrate the present invention, the user browses the window 321 of the computer screen 32 by operating the mouse device 1, but it is not limited to the example actually. Any person skilled in the art could make any equal change design based on practical application requirements. In this preferable embodiment, the user can switch the resolution of the scroll wheel 12 to a first scroll wheel resolution, a second scroll wheel resolution or a third scroll wheel resolution by operating the scroll wheel resolution switching element 13; when the user switches the resolution of scroll wheel to the first scroll wheel resolution by operating the scroll wheel resolution switching element 13 and rotates the scroll wheel 12, the scroll wheel resolution switching element 13 may output a first scroll wheel resolution signal S31, and the magnetic induction element 14 outputs a corresponding magnetic induction signal S11 according to the amount of rolling of the scroll wheel 12, the processing unit 15 generates and outputs a corresponding control signal S21 to the computer system 3 according to the received magnetic induction signal S11 and the first scroll wheel resolution signal S31, so as to enable the computer system 3 to execute a first instruction, when the computer system 3 executes the first instruction, a scrollbar 3211 of the window 321 of the computer screen 32 slides at a first speed for browsing of the user, at this time, the window 321 of the computer screen 32 has a first browsing speed, and the sliding quantity of the scrollbar 3211 depends on the amount of rolling of the scroll wheel 12 and the sliding speed of the scrollbar 3211.

Still, in this preferable embodiment, when the user switches the resolution of the scroll wheel 12 to the second scroll wheel resolution by operating the scroll wheel resolution switching element 13 and rotates the scroll wheel 12, the scroll wheel resolution switching element 13 outputs a second scroll wheel resolution signal S32, and the magnetic induction element 14 outputs a corresponding magnetic induction signal S12 according to the amount of rolling of the scroll wheel 12, the processing unit 15 generates and outputs a corresponding control signal S22 to the computer system 3 according to the received magnetic induction signal S12 and the second scroll wheel resolution signal S32, so as to enable the computer system 3 to execute a second instruction, when the computer system 3 executes the second instruction, the scrollbar 3211 of the window 321 of the computer screen 32 may slide at a second speed for browsing of the user, at this time, the window 321 of the computer screen 32 has a second browsing speed, and the sliding quantity of the scrollbar 3211 depends on the amount of rolling of the scroll wheel 12 and the sliding speed of the scrollbar 3211.

Still, in this preferable embodiment, when the user switches the resolution of the scroll wheel 12 to the third scroll wheel resolution by operating the scroll wheel resolution switching element 13 and rotates the scroll wheel 12, the scroll wheel resolution switching element 13 may output a third scroll wheel resolution signal S33, the magnetic induction element 14 outputs a corresponding magnetic induction signal S13 according to the amount of rolling of the scroll wheel 12, the processing unit 15 generates and outputs a corresponding control signal S23 to the computer system 3 according to the received magnetic induction signal S13 and the third scroll wheel resolution signal S33, so as to enable the computer system 3 to execute a third instruction, when the computer system 3 executes the third instruction, the scrollbar 3211 of the window 321 of the computer screen 32 may slide at a third speed for browsing of the user, at this time, the window 321 of the computer screen 32 has a third browsing speed, and similarly, the sliding quantity of the scrollbar 3211 depends on the amount of rolling of the scroll wheel 12 and the sliding speed of the scrollbar 3211.

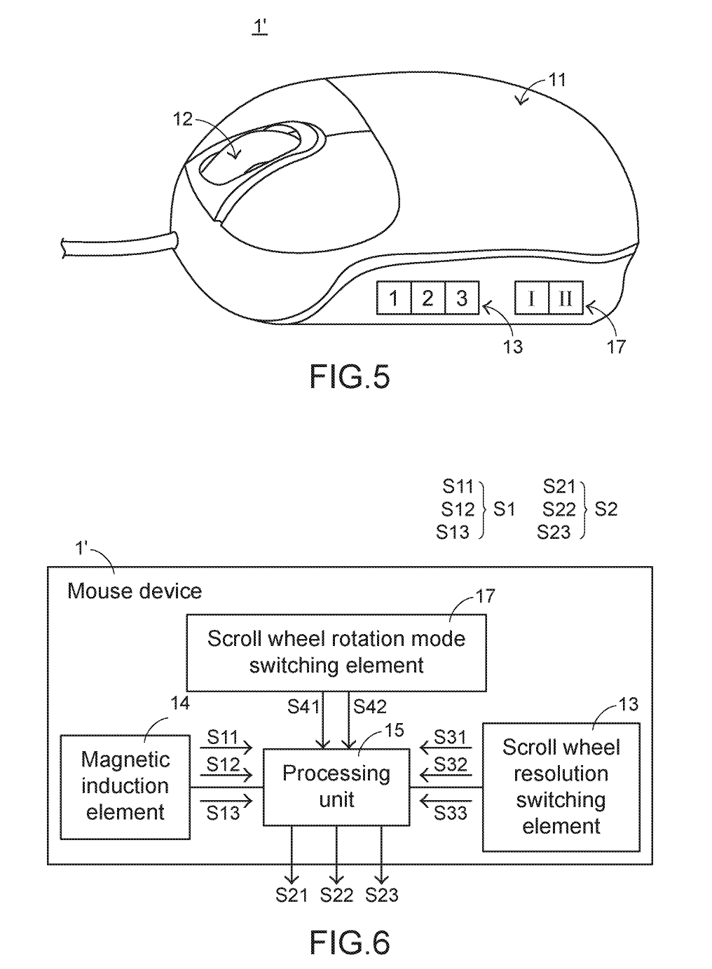

Referring to FIG. 5 and FIG. 6, FIG. 5 is a schematic structural view of the appearance of a mouse device according to a second preferable embodiment of the present invention, and FIG. 6 is a schematic box concept diagram of the mouse device in FIG. 5. A mouse device 1′ of this preferable embodiment is roughly similar to that described in the first preferable embodiment in the present invention, and is not described in detail herein. The difference between this preferable embodiment and the first preferable embodiment is that the mouse device 1′ further includes a scroll wheel rotation mode switching element 17 exposed outside the case 11, the user could switch a rotation mode of the scroll wheel 12 by operating the scroll wheel rotation mode switching element 17, so as to enable the mouse device 1′ to convert from “a stepless scroll wheel rotation mode” to “a stepped scroll wheel rotation mode (at this time, when the user rotates the scroll wheel 12, it is stepped)”, or enable the mouse device 1′ to convert from “the stepped scroll wheel rotation mode” to “the stepless scroll wheel rotation mode”.

In this preferable embodiment, the scroll wheel rotation mode switching element 17 is connected to the processing unit 15, when the user switches the mouse device 1′ from “the stepless scroll wheel rotation mode” to “the stepped scroll wheel rotation mode” by operating the scroll wheel rotation mode switching element 17, the scroll wheel rotation mode switching element 17 may output a first scroll wheel rotation mode signal S41 to the processing unit 15, and enable the mouse device 1′ to be in the stepped scroll wheel rotation mode, and when the user switches the mouse device 1′ from “the stepped scroll wheel rotation mode” to “the stepless scroll wheel rotation mode” by operating the scroll wheel rotation mode switching element 17, the scroll wheel rotation mode switching element 17 may output a second scroll wheel switching element signal S42 to the processing unit 15, and enable the mouse device 1′ to be in the stepless scroll wheel rotation mode. Preferably, but not limited, the scroll wheel rotation mode switching element 17 may be a mechanical switching element, an optical switching element or a touch switching element.

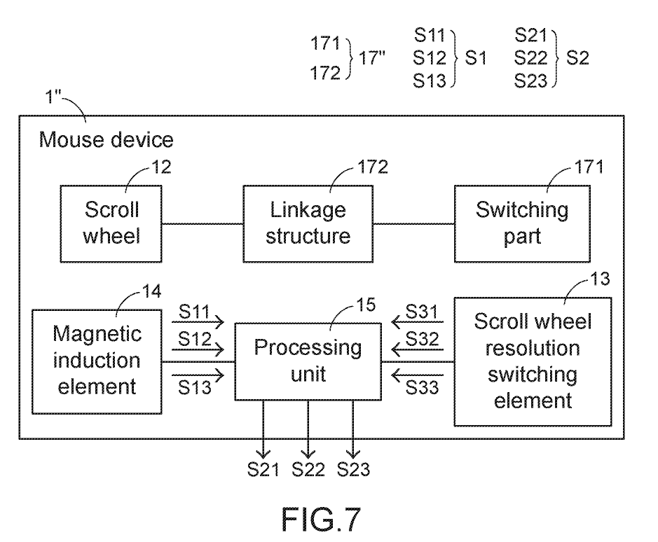

Referring to FIG. 7, FIG. 7 is a schematic box concept diagram of the appearance of a mouse device according to a third preferable embodiment of the present invention. A mouse device 1″ of this preferable embodiment is roughly similar to that described in the second preferable embodiment in the present invention, and is not described in detail herein. The difference between this preferable embodiment and the second preferable embodiment is that a scroll wheel rotation mode switching element 17″ includes a switching part 171 exposed outside the case (not shown in the drawings) of mouse device 1″ and a linkage structure 172 disposed inside the case and between the switching part 171 and the scroll wheel 12. When the user operates the switching part of the scroll wheel rotation mode switching element 17″, the linkage structure 172 may act and change the rotation mode of the scroll wheel 12, so as to enable the mouse device 1″ to convert from “the stepless scroll wheel rotation mode” to “the stepped scroll wheel rotation mode”, or enable the mouse device 1″ to convert from “the stepped scroll wheel rotation mode” to “the stepless scroll wheel rotation mode”.

According to the description above, the mouse device of the present invention obtains the amount of rolling of the scroll wheel when scroll wheel is in stepless rotation or stepped rotation in the way of magnetic induction, and the scroll wheel resolution switching element is disposed for the user to adjust the resolution of the scroll wheel according to the actual application needs, in order to enhance the operation convenience of mouse device for the user, so the mouse device has great industrial utilization value.

The above are only the preferable embodiments of the present invention, and the present invention needs not be limited to the disclosed embodiments. Therefore, all equivalent changes or modifications included within the spirit and scope of the present invention fall within the scope of the claims of the present invention.

What is claimed is:

1. A mouse device, comprising:
a scroll wheel, comprising a magnetic element, and configured to conduct stepless rotation;
a scroll wheel resolution switching element, configured to switch a scroll wheel resolution of the scroll wheel;
a magnetic induction element, outputting a magnetic induction signal according to an amount of rolling of the scroll wheel; and
a processing unit, connected to the scroll wheel resolution switching element and the magnetic induction element, and correspondingly generating and outputting a control signal according to the scroll wheel resolution and the magnetic induction signal.

2. The mouse device according to claim 1, wherein an electronic device receiving the control signal executes a first instruction when the scroll wheel resolution is a first scroll wheel resolution, and the electronic device receiving the control signal executes a second instruction when a scroll wheel resolution signal is a second scroll wheel resolution.

3. The mouse device according to claim 2, wherein the electronic device has a first browsing speed when the electronic device executes the first instruction, and the electronic device has a second browsing speed when the electronic device executes the second instruction.

4. The mouse device according to claim 1, when the scroll wheel resolution switching element is operated and the scroll wheel resolution is switched to a first scroll wheel resolution, the scroll wheel resolution switching element outputs a first scroll wheel resolution signal to the processing unit, and when the scroll wheel resolution switching element is operated and the scroll wheel resolution is switched to a second scroll wheel resolution, the scroll wheel resolution switching element outputs a second scroll wheel resolution signal to the processing unit.

5. The mouse device according to claim 1, wherein the scroll wheel resolution switching element is a mechanical switching element, an optical switching element or a touch switching element.

6. The mouse device according to claim 1, wherein the magnetic induction element is a Hall sensor chip, and the Hall sensor chip is configured to induce a variation in magnetic flux generated when the scroll wheel rotates and correspondingly outputs the magnetic induction signal.

7. The mouse device according to claim 1, further comprising a circuit board, the magnetic induction element and the processing unit being arranged on the circuit board.

8. The mouse device according to claim 1, further comprising a scroll wheel rotation mode switching element, configured to switch the mouse device from a stepless scroll wheel rotation mode to a stepped scroll wheel rotation mode, or switch the mouse device from the stepped scroll wheel rotation mode to the stepless scroll wheel rotation mode.

9. The mouse device according to claim 8, wherein the scroll wheel rotation mode switching element is a mechanical switching element, an optical switching element or a touch switching element.

10. The mouse device according to claim 8, wherein the scroll wheel rotation mode switching element is connected to the processing unit, when the scroll wheel rotation mode switching element is switched, the scroll wheel rotation mode switching element outputs a first scroll wheel rotation mode signal to the processing unit, and enables the mouse device to be in the stepless scroll wheel rotation mode; or when the scroll wheel rotation mode switching element is switched, the scroll wheel rotation mode switching element outputs a second scroll wheel rotation mode signal to the processing unit, and enables the mouse device to be in the stepped scroll wheel rotation mode.
